(19) United States
(12) Patent Application Publication
(10) Pub. No.: US 2003/0046438 A1
(43) Pub. Date: Mar. 6, 2003

(54) Portal for use in-transit with mobile platforms

(76) Inventor: Mary E. O'Donnell, Snoqualmie, WA (US)

Correspondence Address: HARNESS, DICKEY & PIERCE, P.L.C., P.O. BOX 828, BLOOMFIELD HILLS, MI, 48303, US

(21) Appl. No.: 10/170,179

(22) Filed: Jun. 12, 2002

Related U.S. Application Data
(60) Provisional application No. 60/316,444, filed on Aug. 31, 2001.

(51) Int. Cl. G06F 15/16

(52) U.S. Cl. 709/250

(57) ABSTRACT

A business and leisure travel portal provides in-transit content and information to a mobile platform. The content is provided from both an on-board system having predetermined stored data and a remote system providing access to live real-time information using satellite communication. The portal is customizable and provided with various selectable elements for quick access to specific portal content. A user may access the portal with a laptop or similar electronic device. Universal navigation is also provided.

### CROSS-REFERENCE TO RELATED APPLICATIONS

This application claims the benefit of U.S. Provisional Application No. 60/316,444, filed Aug. 31, 2001, the entire disclosure of which is incorporated herein by reference.

### FIELD OF THE INVENTION

The present invention relates generally to electronic communication systems, and more particularly to a system including a portal for providing data to a mobile platform in-transit.

### BACKGROUND OF THE INVENTION

Present day society requires individuals to adhere to very busy schedules. The need for speed permeates many routine daily activities from the desire to more rapidly pay for fuel at the filling stations (e.g., using credit cards at the pump to devices that automatically transmit billing information about the customer) to the need for higher bandwidth for the electronic communication of information between networked computers in large systems. The need for on-demand and up-to-date information that is easily accessible is especially crucial to the success of many companies. From the company selling products on the Internet to the individual “surfing” the World Wide Web (the “Web”) to purchase airline tickets (e.g., using a general or vertical portal to access discounted fare information), timely information communicated at a high transfer rate is extremely desirable. However, because of our mobile environment, this information must be transmitted to individuals that are often times in-transit.

Systems have been developed that increase the speed at which information is transmitted to stationary devices (e.g., systems for transmitting and receiving information at higher transfer rates over the Internet). For example, faster routers and switches determine the destination of data and redirect that data to the desired destination in the fastest, most efficient manner possible. However, people are trading in their desktop computers for laptop computers, their pocket calendars and organizers for personal digital assistants (PDAs) and their pagers (and in some instances their home telephones) for wireless telephones (i.e., cellular telephones and personal communications services (PCS) telephones). All of these devices are typically capable of accessing electronic information either from an internal stored database or from an external source transmitting the information (e.g., the Internet). Web-based content is accessible on a laptop computer by using, for example, a dial-up modem connected directly to a telephone line or to a wireless telephone. Alternately, web-based content is now available directly on a wireless telephone. With the mobile capabilities of these devices, combined with the increased demand for information, a need exists for providing information at a high-transfer rate to these devices while in-transit.

Specifically, an individual in a mobile platform, such as an aircraft, taxi cab or cruise ship may want to access electronic information from the Internet. Alternately, the individual may desire to view live broadcasts of television shows or the like (e.g., a financial news report). Known methods and devices for providing in-transit data not only have limited data content, but are generally cost prohibitive for the average user. For example, connecting a lap-top to a data line on a present day commercial aircraft to send emails can cost in excess of $1.00 a minute with additional connection fees. Further, these systems generally are not user friendly, do not provide for customization and fail to adequately recognize the needs of the in-transit user.

As another example, a traveler on a commercial aircraft may be able to access information regarding stocks or weather using a telephone built-in to the chair back of the seat in front of them. This information is typically hard to access and may have to be viewed on very small screens provided on the telephones. In-flight prerecorded movies or programming may also be provided on various screens throughout the aircraft cabin. However, the user is typically unable to select the programming and oftentimes has a difficult time viewing the movie or pre-recorded television program because of the placement and size of the screens. The limited on-board data content is typically not updated on a timely basis (e.g., a new CD-ROM might be provided only every two or three weeks), thereby resulting in information that is not timely.

These known systems lack the capability to provide information both at a speed required by today's fast paced mobile society and in a user-friendly format or interface that provides access to up-to-date information while a user is in-transit, and further which is capable of providing customized and personalized content.

### SUMMARY OF THE INVENTION

The present invention provides a system including a portal for accessing and requesting information in-transit from a mobile platform. The portal of the present invention is generally a hybrid vertical portal, providing both general and specific content. Both real-time information from a remote system in combination with a satellite communication system and stored predetermined information from an on-board system are accessible using the portal of the present invention. The portal may be customized and/or personalized by a user depending upon individual preferences. The portal may include customizable virtual buttons and content selections that allow for faster access to features and information most frequently accessed by the user. Portal content may be automatically provided or populated based upon the user's destination (which may include intermediate destinations), or alternately, a user may select the portal content by selecting a particular destination of interest (e.g., a future destination). The system and portal may also provide for “surfing” of the Web as is known, when the on-board information is not sufficient.

Specifically, an in-transit (e.g., in-flight) business and leisure travel portal provides in-transit data including, for example, Web-content and live broadcast. A user interfacing with the portal accesses modules, which may include “travel tool” virtual buttons for quickly and easily accessing travel information relating to bookings, airline fares, destination and flight connection information, as well as non-travel information relating to business, news, financial, entertainment, shopping and sports information. Additional modules may be provided for quickly accessing other specific information, for example, stock indexes, current weather, and sports scores.

Some of the content is displayed as textual modules and may include, for example, up-to-date headlines and information, current regional, national and international weather, breaking news headlines and sports scores. Providing textual modules minimizes the system requirements when accessing, for example, visual content.

The invention preferably provides some data from an on-board component or system (e.g., an on-board database server) having data stored within the system on the mobile platform. This data is updated at specified intervals or at specific times. For example, on a long flight this data might be updated while most passengers are sleeping or if the data is more time sensitive, the data may be updated at shorter intervals, such as, for example, every fifteen minutes. Accessing this on-board data minimizes the need to access ground stations (using a satellite system) in order to provide real-time information. However, the invention provides for access to real-time information using a remote component providing satellite communication, which may provide live television and the capability for “surfing” the Web.

The data and/or portal data content is preferably automatically determined based upon the destination of the mobile platform (e.g., flight destination). Thus, depending upon the particular segment or leg of the trip (i.e., intermediate destination), the portal repopulates its content based upon that destination. However, if a user is traveling on to the final destination of the flight, the user can select that destination, with the portal repopulating content to provide information relating to that final destination. Alternately, a user may choose another city of interest, which may be, for example, a future destination during a vacation or merely a city of interest.

Broadband entertainment, business news and sports, as well as other defined services may also be provided. A user fee or charge may be implemented in combination with accessing the data services provided by the portal.

Custom settings and Web bookmarks may be saved for use in subsequent sessions when accessing the portal. Additionally, these custom settings may be provided to a companion ground based system, thereby allowing for access to the personalized portal content from, for example, a land telephone line.

The portal is preferably adapted for access by a user device, such as a laptop computer or PDA. However, an on-board unit (e.g., a station including a screen and keyboard) may be provided for accessing the portal.

Thus, an on-board, user-friendly, up-to-date business and leisure travel portal is provided for accessing data and other services in-transit using a user device. The portal is not only customizable with the content driven by destination or a user selected alternative, but access to the data is quick and easy. The high rate of speed at which data is provided to the mobile platform results from the combination of an on-board component providing stored data (e.g., information that is not time sensitive) and a remote component providing up-to-date real-time information and broadband entertainment and services using satellite communication. Links to access further information may be provided. A user-friendly system having a portal that meets the demands of our fast paced mobile society is thereby provided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram of a system having a portal constructed according to the principles of the present invention;

FIG. 2 is a block diagram of a system having a portal constructed according to the principles of the present invention;

FIG. 3 is a layout diagram showing the content layout of a portal of the present invention;

FIG. 4 is a flow chart showing a content navigation map for a miscellaneous page of a portal of the present invention;

FIG. 5 is a flow chart showing a content navigation map for a travel page of a portal of the present invention;

FIG. 6 is a flow chart showing a content navigation map for a business page of a portal of the present invention;

FIG. 7 is a flow chart showing a content navigation map for a news page of a portal of the present invention;

FIG. 8 is a flow chart showing a content navigation map for a weather page of a portal of the present invention;

FIG. 9 is a flow chart showing a content navigation map for a sports page of a portal of the present invention; and

FIG. 10 is a flow chart showing a content navigation map for an entertainment page of a portal of the present invention.

### DETAILED DESCRIPTION OF THE PREFERRED EMBODIMENTS

The following description of the preferred embodiments is merely exemplary in nature and is in no way intended to limit the invention, its application, or uses. Thus, although the application of the present invention as disclosed herein is directed to an aircraft environment, with the portal being an in-flight portal, it is not so limited and may be provided as an in-transit portal in connection with any mobile platform (e.g., train, cruise ship, automobile, etc.).

Referring to FIG. 1, a portal system 20 in accordance with a preferred embodiment of the present invention is shown. The portal system 20 includes an in-flight portal 22. The in-flight portal 22 communicates with a content management system 24 that provides data and other content for use by the in-flight portal 22. Different types of content may be provided including destination driven data 26, general data or content 28, broadband data 30 and personalized/customized data 32.

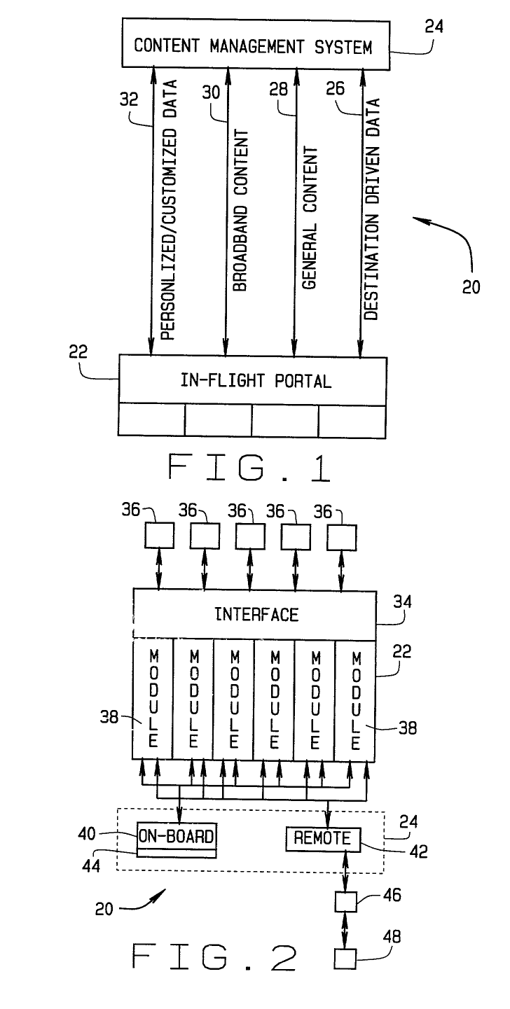

As shown more specifically in FIG. 2, the in-flight portal 22 is preferably provided with an interface 34 to communicate with independent user units 36 to provide data and content to the user units 36 and respond to requests for information from the users. The user units 36 may include, for example, laptop computers or PDAs connected to the system interface 34 in a known manner to receive electronic information (e.g., using the laptop's modem or an Ethernet card connected to the interface 34 to communicate with the portal 22 to receive in-transit content). However, built-in displays or portable devices may be provided on the mobile platform for accessing information using the portal 22.

The in-flight portal 22 preferably includes a plurality of modules 38 as described herein for providing specific functionality. The content management system 24 includes an on-board component or system 40 (e.g., a server on-board the mobile platform for communicating predetermined stored data content or information) and a remote system or component 42 (e.g., a server for communicating real-time information from the Web using satellite communication). The on-board component 40 preferably includes a storage unit 44 for providing the stored predetermined data and content to the in-flight portal 22. The remote component preferably communicates with a satellite system 46 for transmitting requests from the user using the user device 36 and receiving real-time information from a ground based system 48 (e.g., a ground-based server providing Web content and/or broadband services). Therefore, depending upon the specific data to be provided to or requested by a user, the system 20 can directly access predetermined stored on-board data, or request up-to-date real-time data.

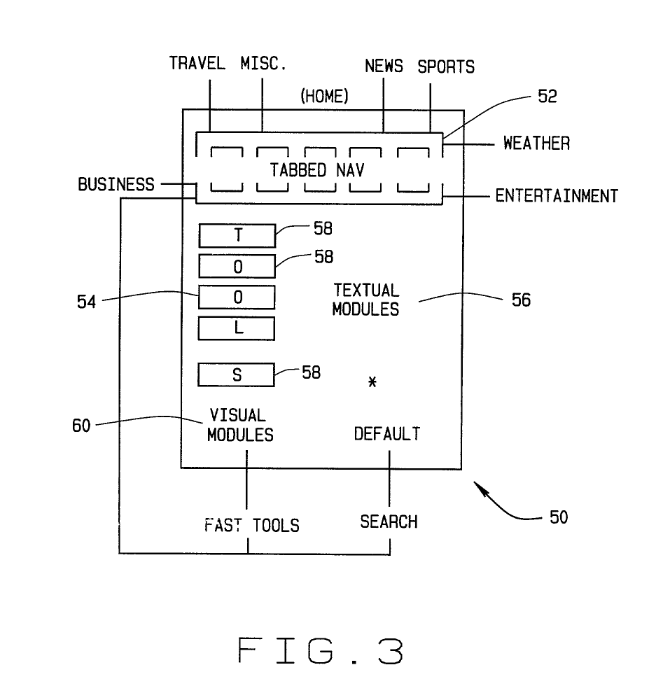

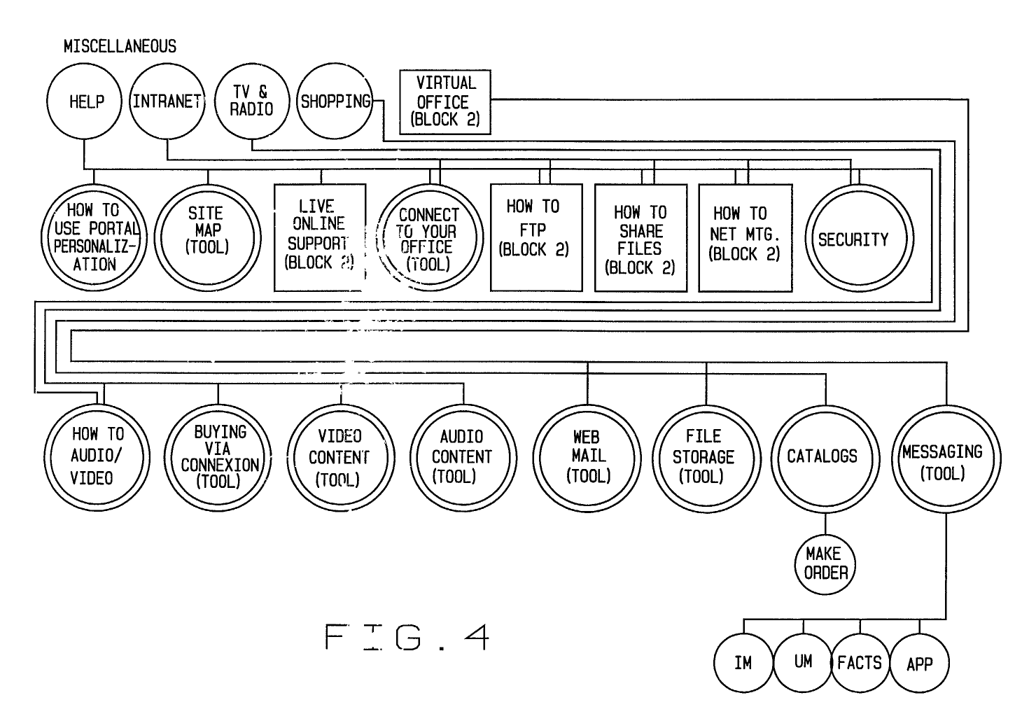

Generally, the in-flight portal 22 is adapted for navigation such that a user preferably may select or jump directly to one of a plurality of sections or areas (e.g., a separate page in the in-flight portal 22) in the site. Each section or area preferably includes data content relating to a distinct topic or category of information. One particularly preferred layout 50 of the in-flight portal 22 is shown in FIG. 3. The content of the home screen or page is preferably adapted for customization by the user as described herein.

Specifically, portal content is preferably arranged into business travel and leisure travel topic areas along with general global portal content that may include, for example, links to other content or sites. Links may also be provided within each specific topic area. With respect to the general content, the in-flight portal 22 may provide data relating to, but not limited to, business, news, weather, sports, entertainment, shopping and culture.

More preferably, portal content is represented on the portal home in compact headed columns as part of a universal navigation component 52 as representatively shown in FIG. 3. These columns within the universal navigation component 52 may include virtual buttons for selecting the specific content. The content preferably includes up-to-date information for each category, such as, for example, deals on airfare, corporate rates on accommodations, current weather, breaking news headlines and sports scores. Preferably, this information is updated approximately once each hour using satellite system 46. Clicking or selecting the header or featured virtual button directs the user to the page for that topic. Clicking or selecting any of the specific up-to-date content in a column preferably directs the user to a story or information on the main page regarding that content. Further, depending upon screen size, a user may have to scroll up or down the screen to locate specific information.

It should be noted that when reference is made to a page or content on a screen, this includes any data or related content, such as for example, web content on a laptop computer screen connected to the interface 34 or live transmission, such as for example, streaming video or television broadcasts. When reference is made to portal content, this refers to the data or information provided electronically to the user for viewing on a user unit 36. When reference is made to clicking on or selecting specific content or a virtual button (e.g., a visual representation of a button or an icon on a screen) on a page, this refers to moving a pointer or similar representation using a computer mouse, glide pad or similar device and activating that selection with the computer mouse or glide pad. Jumping from one page to another refers to selecting a link or other element that changes the content on the screen to the selected category or data.

Modules 38 are preferably included to provide quick access to related information, with links preferably represented as buttons within a tools palette 54. These modules 38 include feature modules (e.g., providing access to featured content) that are preferably represented as small color-keyed information side-bars on the in-flight portal 22 and are modular such that they can be moved and inserted into different pages throughout the in-flight portal 22. It should be noted that when reference is made to modules this generally refers to a separate unit of software or hardware for performing a particular function (e.g., accessing specific portal content).

Specifically, and referring again to FIG. 3, the universal navigation component 52 is preferably provided as headed columns and displayed along the top of the main or home page and the textual content modules 56 are displayed along the lower right portion of the screen. Promotional advertising may be provided throughout the in-flight portal 22. A status clock may also be provided in the upper right corner of the in-flight portal 22 to track the time of use (e.g., amount of time a particular user has been accessing the in-flight portal 22). A further navigation tool may also be provided for new users represented as a small virtual remote control displayed in a small window for navigating main topic areas. The main home categories for providing content preferably include the following: home, business, entertainment, miscellaneous, news, sports, travel and weather, which are preferably represented within the universal navigation component 52.

The headed content modules within the universal navigation component 52 preferably provide the most significant up-to-date headlines and information such as weather, news headlines and sports scores. Links are preferably provided to access further related information in each topic area. Fast tool buttons 58, incorporated as part of the tools palette 54, provide quick access to user determined content. These buttons 58 are preferably user personalizable and provide one-click jumps to other pages, feature areas, URLs and other links. The fast tool buttons 58 preferably default to selected content and are provided with default icons on each. The in-flight portal 22 is adapted to provide for adding, deleting or modifying the default buttons 58.

Visual modules 60 preferably represented as small, dynamically updated colorful visual info-graphics provide quick access to related information. A user may select visual modules to display or persist throughout the in-flight portal 22. A personalized set of visual modules is thereby provided throughout the in-flight portal 22 according to a particular user's preferences.

On the home (or front) page, the visual modules 60 and textual content modules 56 preferably extend to encompass the screen. In a default state, the home page displays a sampling of content throughout the main pages along with the default set of visual modules 60.

With respect to real-time or live content, such as for example, streaming media or live television, “pop-up” windows are preferably provided as separate content for isolating viewing while maintaining the source page in the background. The “pop-windows” may be sized or moved within the source page depending upon the preferences of the user. This also provides for ease in switching between site content, cached catalogs, or the Web, while the live content continues playing.

The universal navigation of the in-flight portal 22 (i.e., consistent from page to page) provides a user with the capability to jump or move between and directly to any main area of the portal (i.e., select a different category within the in-flight portal 22). A user-friendly environment for quickly accessing information is provided. The universal navigation aspect of the in-flight portal 22 is preferably adapted for customization to provide only the particular areas of interest to a user.

Promotion advertising may be provided as part of the in-flight portal 22. This advertising may be specifically selected depending upon past activity of a particular user. The administration of advertising and other aspects of the in-flight portal 22 are preferably provided within secured administrative sections. An introductory screen may be provided that includes promotions or animations and is preferably provided from the on-board server or component 40.

Specific main pages are provided as part of the in-flight portal 22 and may include searching, tours, feedback, billing, account, help and registration components. With respect to specific pages, a search page preferably provides for entering search criteria. The search may be limited to the on-board server 40 or may include a search of the Web using the remote server 42. When a default search is requested, the most recent information is preferably provided from the on-board server 40. Thus, speed of access is maintained through “on-board surfing.” Web searches may also be provided in a typical manner using any of the search engine sites available on the Web. In addition to the main search page, a customizable advanced search page may be provided.

A contact page provides for contacting the administrator of the in-flight portal 22. An account page is also provided to view account and billing information such as the current amount charged to the user for accessing the in-flight portal 22. Additionally, pricing for other services, such as the Internet, live television, and access to an intranet may be provided. Complaint forms may also be provided as part of this page.

A registration page allow users to login to or sign-up (for first time users) for the in-flight portal 22. Registration information may be used to provide specific predetermined content to a particular user (e.g., advertising content). The system 20 preferably monitors and reports user activity, with data relating to users stored in a customer database. User registration and authentication is also preferably provided.

With respect to the various content preferably provided by the in-flight portal 22 on main pages that are preferably accessed using the headed universal navigation component 52 (which may be tabbed), a business travel page preferably includes travel information and resources for the in-flight business person. For example, access may be provided to bookings for all aspects of business travel, airport information, ticket and flight information, business travel tips and advisories, featured destination information, general destination information, shopping for the business traveler, and links to other business travel sites on the Web. This page may also include travel stories hosted by, for example, guest celebrity CEOs.

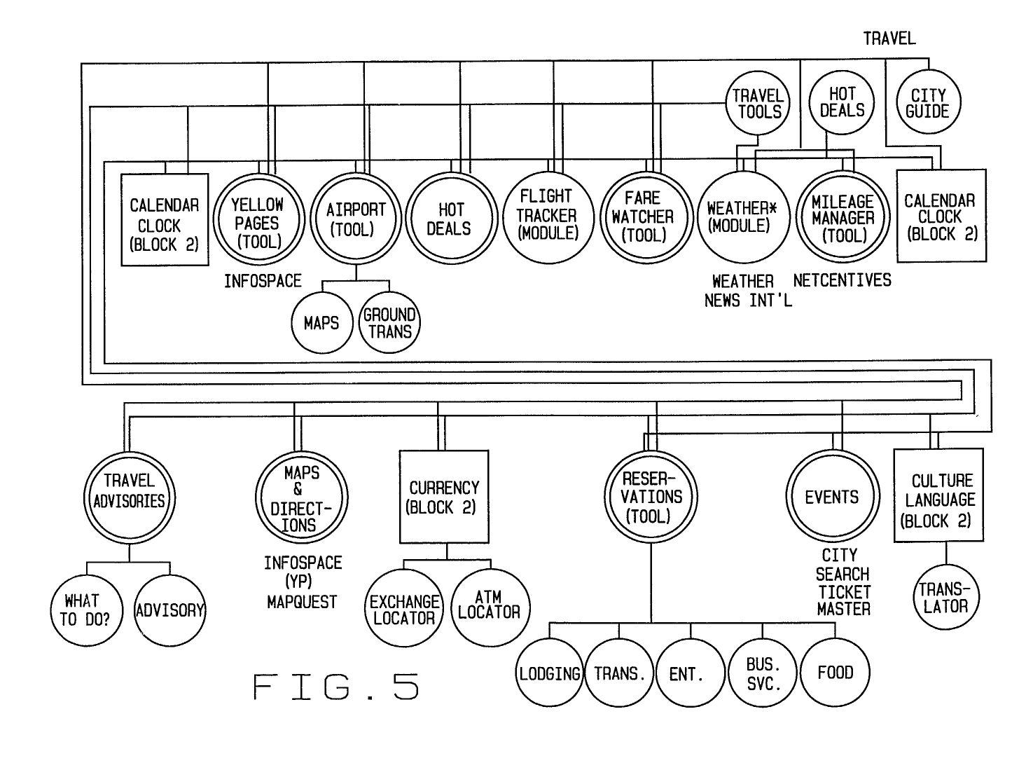

A miscellaneous page provides access to information having explanations relating to specific features of the in-flight portal 22. General help, as well as specific help on a particular topic may be provided. Additionally, this page provides access to intranet connectivity and shopping. As shown in FIG. 4, the main miscellaneous content categories preferably include the following: help, intranet, television and radio, shopping and virtual office. The virtual office preferably allows users to log on to their company intranet to thereby provide similar services available in an office business center (e.g., faxing, messaging, conference facility reservations, etc.). Links may also be provided to business and company news worldwide.

The general travel or leisure travel page preferably provides general travel information and resources, including for example, access to bookings for all aspects of travel, airport information, ticket and flight information, travel tips and advisories, featured destination information, general destination information, shopping for the general traveler, and links to other travel spots on the Web. Feature travel stories hosted by, for example, guest celebrity travel authors, may be provided. Video (e.g., an MPEG) of celebrity hosts sharing travel anecdotes and stories may be provided. Preferably, the content on this page includes data related to entertainment and leisure-oriented topics. As shown in FIG. 5, the main travel content categories preferably include the following: travel tools, hot deals and city guide. It should be noted that a user's personal travel preferences are preferably stored in related travel services content areas (e.g. booking, reservation preferences for hotels, airlines, car rentals, frequent flyer mileage, and other personal travel preferences).

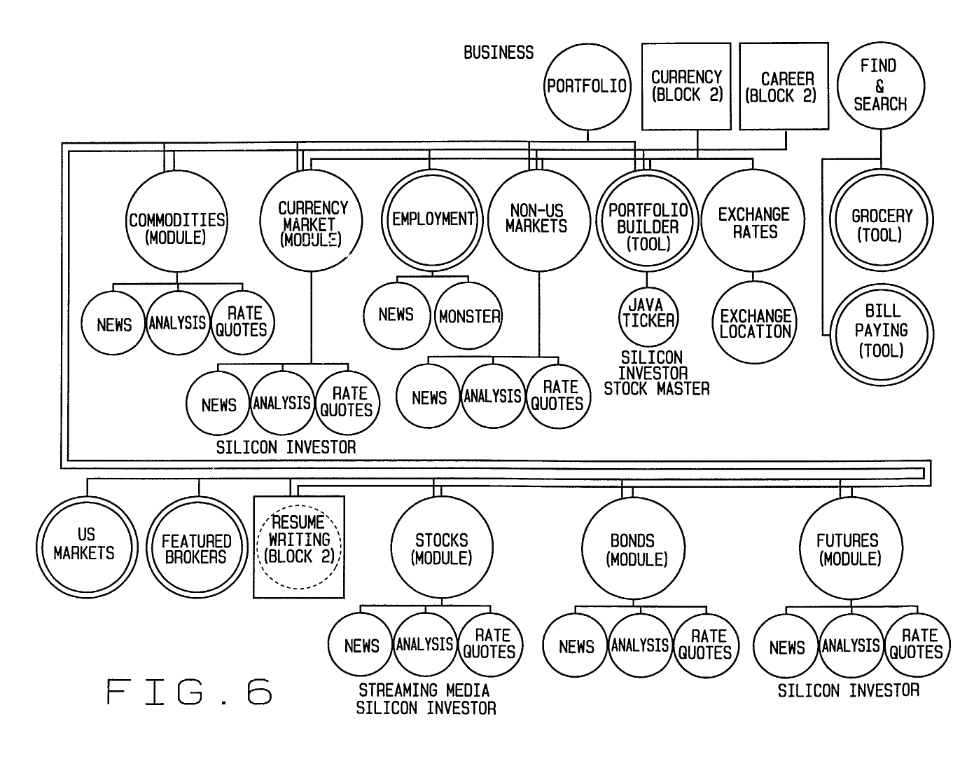

A business page preferably provides content relating to national and international news and information, including, breaking news, financial and stock exchange information, live television, streaming media news and area-specific weather. As described herein, real-time information is provided using the remote server 42, while predetermined stored information is provided using the on-board server 40. Feature visual modules 60 may be provided in connection with this page, and may include weather and market and stock information. The main business content categories as shown in FIG. 6 include the following: portfolio, currency, career and find and search.

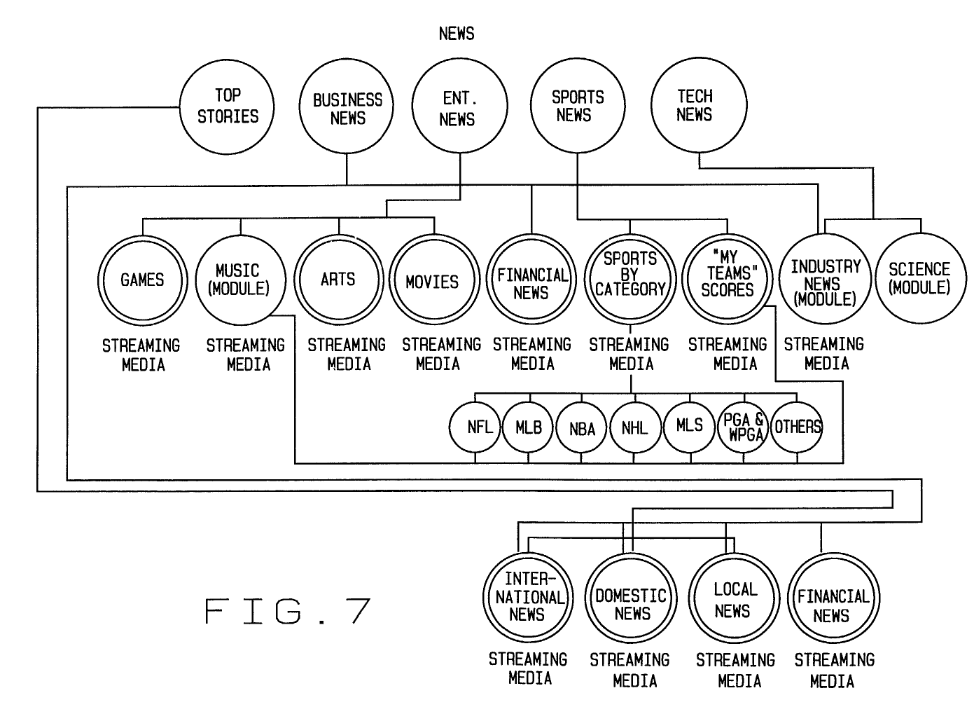

A news page preferably provides current local, national and international news. Live television and streaming news may be provided. Typically this requires plug-ins for viewing (e.g., RealPlayer). These plug-ins are preferably provided as part of the in-flight portal 22. Weather information for a particular location may be provided (e.g., destination city). Feature modules 60 may be provided in connection with this page, and may include, for example, information relating to medicine and science and display hyperlinked headlines of the latest breaking news worldwide. As shown in FIG. 7, the main news content categories preferably include the following: top stories, business news, entertainment news, sports news and technology news.

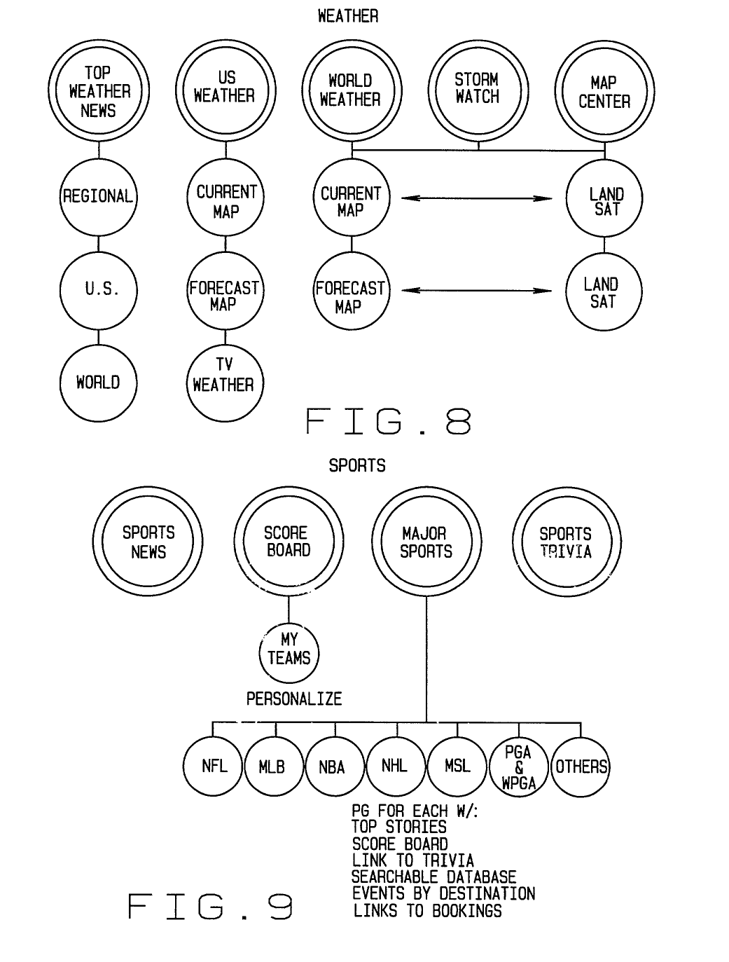

A weather page preferably provides real-time information regarding current national and international weather. A user can select area-specific weather news with the content preferably refreshing frequently (e.g., once per hour). Feature modules 60 may be provided in connection with this page adapted to quickly access local and worldwide airport weather information, weather forecasts and weather advisories. As shown in FIG. 8, the main content categories preferably include the following: top weather news, United States weather, world weather, storm watch and map center.

A sports page preferably provides sports news for national and international sports, and for seasonal sporting events. This page may provide streaming media and access to live television, such as for example, ESPN®. As shown in FIG. 9, the main sports content categories preferably include the following: sports news, score board, major sports and sports trivia.

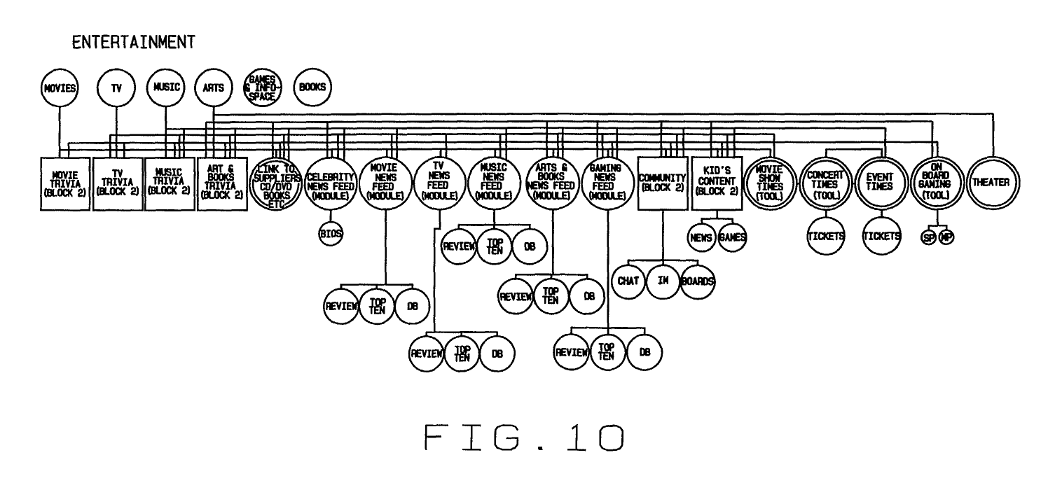

An entertainment page preferably provides news and information about national and international movies and television, as, well as providing streaming media and live television. This page preferably provides a list of television schedules and features top movies of the week and a choice of music (e.g., listening to MP3 format music while accessing the in-flight portal 22). Both broadband prerecorded (from the on-board server 40) and live entertainment (from the remote server 42) is preferably provided. This page, as well as others, may provide specific content or sections for children. The children's section and/or other sections may include a filter to reduce, and preferably eliminate the likelihood of accessing inappropriate content. The main entertainment content categories as shown in FIG. 10 preferably include the following: movies, television, music, arts, games and infospace, and books.

A shopping page preferably lists all on-board cached catalogs with the ability to search the catalogs based upon specific products, brand names, etc., and then purchase the products on-line using the in-flight portal 22. Alternately, instead of accessing on-board catalogs from the on-board server 40, users may access the Web to shop on-line using the remote server 42. It should be noted that this page, like other pages and aspects of the in-flight portal 22 preferably provide stored or cached information from the on-board server 40 first, unless otherwise requested or configured. However, access to other live content may be provided using the remote server 42.

A culture page preferably provides region-specific information, including content related to art, music, food, lodging and historical data. This page may also provide streaming media and special television channels such as A&E, Discovery®, the History Channel® and PBS®.

With respect specifically to user customization, the in-flight portal 22 content is preferably destination driven (i.e., populated with content relating to the mobile platform's destination city). The in-flight portal 22 is adapted for modification with a user selecting a different destination city of interest. Selection of an alternate city preferably automatically repopulates the content of the in-flight portal 22 to include information relating to the selected destination city. Several personalization options are preferably provided as follows: (1) Master personalization allowing users to change the overall layout of the in-flight portal 22 display, such as for example, surrounding colors, content category positions and persistence of visual modules and tools throughout the portal site; and (2) Content personalization allowing the user to specify the default content on their display when accessing the in-flight portal 22. The content personalization includes modifying the content associated with each module header and removing modules. It should be noted that a reset to default element is preferably provided to return the content on the in-flight portal 22 to an original default state.

The in-flight portal 22 is further adapted for adding or deleting certain areas and/or types of content (e.g., site settings). Users may save bookmarks and create customized profiles having information such as for example, hotel, airline and car preferences, frequent flyer and hotel member numbers, and other personal travel preferences. This information is preferably automatically provided throughout the in-flight portal 22 when a user performs specific functions, for example, when purchasing tickets using the in-flight portal 22. Alternately, information regarding user membership numbers, etc. may be provided as part of a separate partnership page.

The system 20 for implementing the in-flight portal 22 of the present invention is preferably provided with security, which may include strong encryption (SSL), validation and dynamic log analysis.

Preferably, the in-flight portal 22 is implemented on an Internet client/server architecture supporting an established networking topology for in-flight systems. Scripting preferably supports dynamic analysis of the user's interface system (e.g., Netscape® or Internet Explorer®). The system 20 preferably determines the type of browser in use and customizes content delivery based upon the capabilities of the browser. The system 20 preferably uses HTML, DHTML and CSS standards supported by version 4.0 browsers and higher. The system 20 also preferably includes client-side scripting (Java® Script) and executable code (Java®) supported by the browser versions. Flash requirements are also preferably supported by the system 20.

The in-flight portal 22 is preferably implemented using selected industry-standard integrated development environments (IDE) with scripting languages selected based upon portal requirements and providing middleware that is platform independent (e.g., may be used on UNIX® or Windows NT®). Preferably, Cold Fusion®, Java®, Flash and Oracle® may be used to implement the database backend of the system 20. The various servers and components may be implemented using various operating systems, including for example, Windows NT®, UNIX® and Linux®, and web server software, including Microsoft® Internet Information Server and Apache® Web Server may be implemented.

Although the in-flight portal is described in connection with the system 20, it should be appreciated that other systems, including different server and communication configurations may be used and implemented in combination with the in-flight portal 22 to provide both stored predetermined content and live real-time content. Thus, the on-board component 40 and remote component 42 may be implemented and configured according to the requirements of the particular mobile platform. Further, the content on a particular page or relating to a particular category may be modified to include data related to any topic. Also, any content provided may be stored on-board, accessed real-time or a combination of both depending upon the particular requirements of the system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for providing data in-transit to a mobile platform using a portal, the system comprising:
an interface for connecting to the portal to access in-transit data from the portal; and
a content management system providing data from at least two sources for use in-transit with the mobile platform, and wherein one source is on-board the mobile platform and the other source is remote from the mobile platform.

2. The system according to claim 1 wherein the content management system comprises:
a remote component for providing real-time data to the portal from the remote source as requested by in-transit users of the mobile platform connected to the interface; and
an on-board component for providing stored data to the portal from the on-board source as requested by in-transit users of the mobile platform connected to the interface.

3. The system according to claim 2 wherein the on-board component and remote component each comprise servers, and wherein the system further comprises a user device for connecting to the interface to access data.

4. The system according to claim 3 wherein the on-board server further comprises an updateable storage device for storing predetermined data.

5. The system according to claim 4 wherein the updateable storage device is configurable to dynamically receive updated information at predetermined time intervals.

6. The system according to claim 3 wherein the mobile platform is an aircraft and the control is configured to automatically provide data relating to the flight destination to the user device from the sources.

7. The system according to claim 2 further comprising a communication system in combination with the remote component for transmitting and receiving real-time information using satellites.

8. The system according to claim 2 further comprising a user device for connecting to the interface to access selectable data as requested by a user.

9. The system according to claim 8 wherein the user device is adapted for web-based communication and the real-time information emanates from the Internet.

10. The system according to claim 9 further comprising a user database for storing user preferences and wherein the in-transit data accessed using the interface is determined in part by the user preferences.

11. The system according to claim 1 further comprising a plurality of modules for selectively accessing the in-transit data.

12. The system according to claim 1 further comprising tracking means for use in determining user patterns relating to accessing the in-transit data.

13. A portal for providing data in-transit to a mobile platform for access by a user having a device adapted for receiving the data from the portal, the portal having a plurality of predefined categories of data content and comprising:
a navigation element for selecting data content from one of the plurality of predefined categories;
a plurality of selectable modules for accessing specific data content corresponding to each of the predefined categories; and
a plurality of customizable elements for selecting user defined data content.

14. The portal according to claim 13 wherein the navigation element is configured for access within each of the plurality of predefined categories of data content.

15. The portal according to claim 14 wherein the plurality of selectable modules comprises visual modules for selecting specific data content.

16. The portal according to claim 15 wherein the visual modules are configured for personalization.

17. The portal according to claim 16 wherein the content comprises both predetermined stored data content and real-time data content and wherein the selectable modules and customizable elements are configured to provide predetermined stored data content before real-time data content.

18. The portal according to claim 13 wherein the user device comprises an electronic device having a browser for accessing the portal and the data is configured for transmission to the electronic device depending upon the type of browser.

19. The portal according to claim 13 wherein the data content is provided based upon a user destination and wherein the selectable modules are configured to provide data content relating to the user destination.

20. A method of providing information in-transit to a mobile platform using a portal, the method comprising the steps of:
using an on-board system to provide stored data to the portal for access by a user on the mobile platform; and
using a remote system having satellite communication to provide real-time data to the portal for access by a user on the mobile platform.

21. The method according to claim 20 further comprising the step of using the on-board system to provide data before using the remote system to provide data.

22. The method according to claim 20 wherein the user accesses in-transit data using a device having an interface, and further comprising the step of automatically determining the type of interface.

23. The method according to claim 20 wherein the mobile platform is in-transit to a destination and further comprising the step of transmitting automatically to the device data relating to the destination of the mobile platform.

24. The method according to claim 20 further comprising the step of transmitting automatically to the device data related to a user selected destination.
